(19) United States
(12) Patent Application Publication
(10) Pub. No.: US 2025/0299316 A1
(43) Pub. Date: Sep. 25, 2025

(54) IMAGE INSPECTION DEVICE

(71) Applicant: Keyence Corporation, Osaka (JP)

(72) Inventors: Daisuke YAMAMOTO, Osaka (JP); Keisuke FUKUTA, Osaka (JP); Yuichiro HIDA, Osaka (JP)

(73) Assignee: Keyence Corporation, Osaka (JP)

(21) Appl. No.: 19/049,058

(22) Filed: Feb. 10, 2025

(30) Foreign Application Priority Data
Mar. 19, 2024 (JP) 2024-043886

(51) Int. Cl. G06T 7/00; G06V 10/764

(52) U.S. Cl. CPC G06T 7/0006; G06V 10/764; G06T 2207/20081

(57) ABSTRACT

An inspection device extracts, from a learning image, a first feature amount that reflects an angle of a window and a position specified by the window, and a second feature amount corresponding to a position specified by the window. The inspection execution section extracts a third feature map from the captured image, determines a candidate region based on the third feature map and the first feature amount, extracts a fourth feature map from the captured image, and makes a classification based on the fourth feature map, the candidate region, and the second feature amount, and outputs the inspection result in which the candidate region is set as a detection region of the object in a case where a fourth feature amount corresponding to the candidate region is classified as belonging to the same class as the second feature amount.

### CROSS-REFERENCE TO RELATED APPLICATIONS

The present application claims foreign priority based on Japanese Patent Application No. 2024-043886, filed Mar. 19, 2024, the contents of which are incorporated herein by reference.

### BACKGROUND OF THE INVENTION

### 1. Technical Field

The present disclosure relates to an image inspection device.

### 2. Description of the Related Art

In related art, there has been known an image inspection device including a “learning tool” that is a tool for setting a condition for determining whether or not an object is a non-defective product (see, for example, JP2022-164146A).

In a case where a position and an angle of an inspection target region (ROI: region of interest) of the “learning tool” are fixed with respect to a capturing field of view, when the object appearing in an inspection target image is out of the ROI, the determination as whether or not the object is the non-defective product cannot be performed.

In order to solve the above problems, for example, the image inspection device includes a “position correction tool” disclosed in JP2022-164146A.

### SUMMARY OF THE INVENTION

A reference position and a reference angle are set in the capturing field of view by the “position correction tool”, and the position and the angle of the ROI are adjusted with respect to the capturing field of view according to the reference position and the reference angle.

However, when a visual characteristic suitable for setting the reference position and the reference angle of the “position correction tool” is not included in the inspection target image, it is difficult to appropriately adjust the ROI by the “position correction tool”.

In view of the above problems, the present disclosure provides an image inspection device capable of inspecting any object of a captured image without a user setting an ROI.

According to one embodiment, an image inspection device includes an image capturing section that captures a capturing field of view to generate a captured image, an inspection execution section that detects an object from the captured image by a machine learning model to output an inspection result, and an inspection setting section that performs setting of the inspection execution section. The machine learning model includes a first feature extraction section and a second feature extraction section that extract feature amounts from an input image, and a determination section that outputs the inspection result from the feature amount. The inspection setting section receives window setting of a window for a learning image, executes the first feature extraction section to extract a first feature map from the learning image, and extracts a first feature amount that is included in the first feature map, reflects an angle of the window with respect to the learning image, and corresponds to a position specified by the window, executes the second feature extraction section to extract a second feature map from the learning image, and extracts a second feature amount that is included in the second feature map and corresponds to a position specified by the window. The inspection execution section executes the first feature extraction section to extract a third feature map from the captured image, specifies a position corresponding to a third feature amount included in the third feature map and similar to the first feature amount, and determines a candidate region based on the specified position and the window setting, executes the second feature extraction section to extract a fourth feature map from the captured image, and classifies whether or not a fourth feature amount included in the fourth feature map and corresponding to the specified position belongs to the same class as the second feature amount, and outputs the inspection result in which the candidate region is set as a detection region of the object in a case where the fourth feature amount is classified as belonging to the same class as the second feature amount.

Note that, other characteristics, elements, steps, advantages, and features will be more apparent from the following detailed description and the accompanying drawings.

With the image inspection device according to the invention, the user can inspect any object of the captured image without setting the ROI.

### BRIEF DESCRIPTION OF THE DRAWINGS

FIG. 1 is a diagram for describing an image inspection device according to an embodiment of the invention at the time of an operation;

FIG. 2 is a hardware configuration diagram of the image inspection device;

FIG. 3 is a functional block diagram of the image inspection device;

FIG. 4 is a diagram illustrating a flow in a setting mode;

FIG. 5 is a diagram illustrating a graphical user interface [GUI]transition of FIG. 4;

FIG. 6 is a block diagram of a machine learning model;

FIG. 7 is a block diagram of the machine learning model;

FIG. 8 is a block diagram of the machine learning model;

FIG. 9 is a diagram illustrating a detection result image;

FIG. 10 is a diagram illustrating the detection result image;

FIG. 11 is a diagram illustrating the detection result image; and

FIG. 12 is a diagram illustrating the detection result image.

### DETAILED DESCRIPTION

Hereinafter, embodiments of the invention will be described in detail with reference to the drawings. Note that, the following description of preferred embodiments is merely exemplary in nature and is not intended to limit the invention, an application thereof, or an intended use thereof.

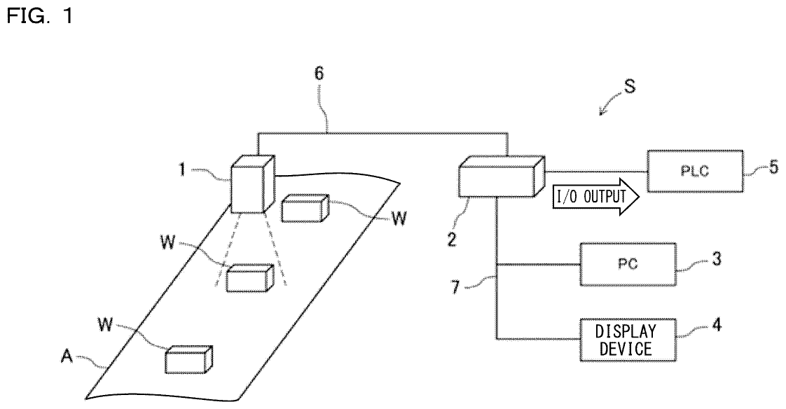

FIG. 1 is a diagram for describing an image inspection device S according to an embodiment of the invention at the time of an operation. For example, the image inspection device S captures workpieces W conveyed by a conveyance unit A according to capturing settings to acquire captured images, detects the workpieces W in the acquired captured images, and outputs a detection result to an external device. Examples of the external device include a programmable logic controller (PLC) 5 and the like, but a device other than the PLC 5 may be an external device. Based on the received detection result, the PLC 5 controls the conveyance unit A so as to separate storage destinations of the workpieces W, for example. In the following description, a case where the external device is the PLC 5 will be described. Note that, the workpiece W may be a workpiece that is not conveyed by the conveyance unit A. In addition, in the following description, the workpiece is also referred to as an object. Note that, in the following description, the entire workpiece is the object, but the object may be a part of the workpiece.

The image inspection device S includes an image capturing unit 1 for capturing an image of the workpiece W, a control unit 2 to which a captured image captured by the image capturing unit 1 is input, a personal computer (PC) 3 for performing settings and the like of the image inspection device S, and a display device 4 for displaying a setting screen, a selection screen, a workpiece image, a detection result, and the like. In the control unit 2, a trained model for detecting the workpiece W in the input captured image is executable. The control unit 2 executes an output corresponding to the detection result by the trained model for the PLC 5.

Here, the image inspection device S may be used, for example, when the workpiece W is inspected from various angles at each point of a manufacturing apparatus or a manufacturing line. Thus, a plurality of image inspection devices S may be installed in one manufacturing apparatus or one manufacturing line, and it is conceivable that an installation space and a power supply cannot be sufficiently secured. Accordingly, the image inspection device S needs miniaturization corresponding to the installation space and power saving corresponding to the power supply, and in order to satisfy these needs, the image inspection device S according to the present embodiment does not include a graphics processing unit [GPU]. The control unit 2 executes a trained model in which machine learning is performed to such an extent that the workpiece W can be detected, but the image inspection device S is provided from a vendor to a user such that desired detection accuracy can be obtained even though the user does not perform advanced machine learning that is recommended to use the GPU. Details will be described later. Since the user does not need to perform advanced machine learning, the user can execute a learning model capable of detecting the workpiece W without preparing a GPU suitable for learning. In addition, a time taken by the user to prepare the trained model capable of detecting the workpiece W can be shortened. Note that, one image inspection device S may be installed and operated in a manufacturing apparatus or a manufacturing line. In addition, the image inspection device S can also be referred to as an image sensor.

### (Configuration of Image Capturing Unit)

The image capturing unit 1 is separate from the control unit 2, and is installed so as to be able to capture the workpiece W from a desired direction. The workpiece W is sequentially conveyed by the conveyance unit A to a capturing field of view of the image capturing unit 1.

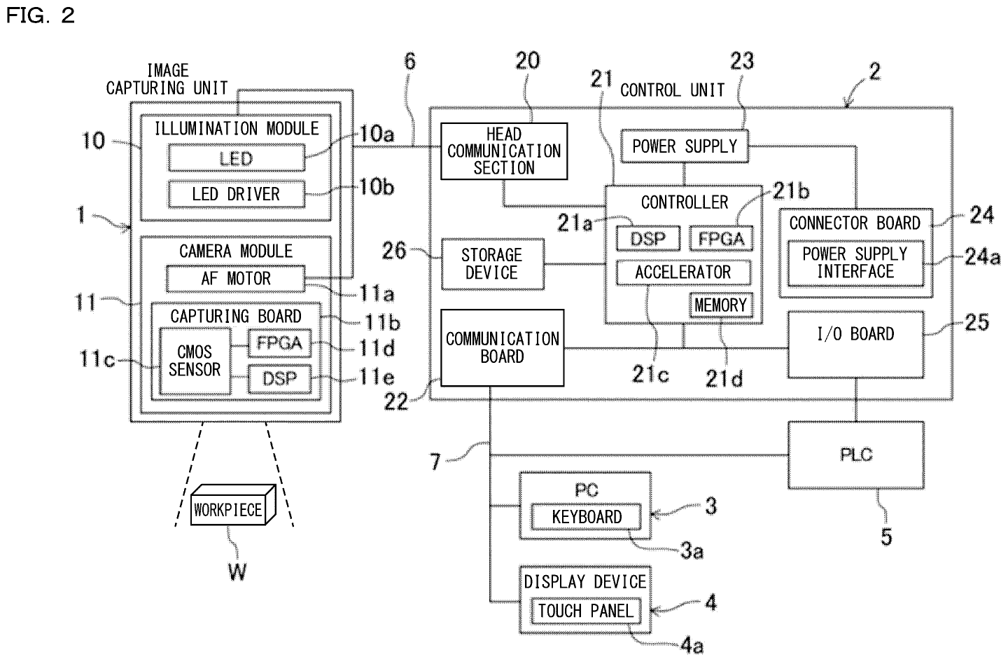

FIG. 2 is a hardware configuration diagram of the image inspection device S. As illustrated in FIG. 2, the image capturing unit 1 includes an illumination module 10 for illuminating the workpiece W and a camera module 11 for capturing an image of the workpiece W illuminated by the illumination module 10.

The illumination module 10 includes a light emitting diode (LED) 10a that irradiates the workpiece W with light, and an LED driver 10b that controls a light amount, a light emission timing, and the like of the LED 10a. The LED driver 10b is connected to a head communication section 20 (to be described later) of the control unit 2, and is controlled by a controller 21 (to be described later) of the control unit 2.

The camera module 11 includes an AF motor 11a and a capturing board 11b. The AF motor 11a is a member for automatically focusing on the workpiece W by driving a focusing lens of an optical system (not illustrated). The autofocusing method is not particularly limited, and examples thereof include a contrast method and a liquid lens method.

The capturing board 11b includes a CMOS sensor 11c, an FPGA 11d, and a DSP 11e. The CMOS sensor 11c is an image sensor that receives reflected light emitted from the LED 10a to the workpiece W and reflected by the workpiece W. The CMOS sensor 11c is connected to the head communication section 20 of the control unit 2, and is controlled by the controller 21 of the control unit 2 to perform exposure processing at a predetermined timing for a predetermined time.

The FPGA 11d is a processing device capable of changing internal processing contents. The DSP 11e is a signal processing device. A light reception amount signal of a light receiving element included in the CMOS sensor 11c is output to the FPGA 11d and processed, and is also output to the DSP 11e and processed. The processing by the FPGA 11d and the DSP 11e is not particularly limited, and examples thereof include various kinds of filter processing. Image data processed by the FPGA 11d and the DSP 11e is transmitted from the image capturing unit 1 to the control unit 2.

The image capturing unit 1 and the control unit 2 are connected via a communication cable 6. Thus, the control unit 2 can be installed at a place away from an installation place of the image capturing unit 1.

### (Configuration of PC)

The PC 3 is constituted by a general-purpose personal computer or the like. In this example, the PC 3 can be used by installing a predetermined program in a personal computer. The PC 3 includes operation devices such as a keyboard 3a and a mouse (not illustrated). The user of the image inspection device S can perform a setting operation and a selection operation of the image inspection device S by operating the operation device of the PC 3. Specific setting operation and selection operation will be described later.

The PC 3 and the communication board 22 of the control unit 2 are connected to communicate with each other, and information based on the setting operation by the user is transmitted from the PC 3 to the control unit 2. In addition, the PC 3 can receive the image data of the workpiece W, the inspection result, and the like output from the control unit 2. The PC 3 and the control unit 2 are connected via a communication cable 7. Thus, the PC 3 can be installed at a place away from an installation place of the control unit 2.

### (Configuration of Display Device)

The display device 4 includes, for example, a liquid crystal display, an organic EL display, or the like. In this example, the display device 4 includes a touch panel 4a. The touch panel 4a is a member capable of detecting an operation by a user's finger. A type of the touch panel 4a is not particularly limited, and examples thereof include a capacitance type and an infrared type. The display device 4 and the communication board 22 of the control unit 2 are connected to communicated with each other. Operation information of the touch panel 4a by the user is transmitted from the display device 4 to the control unit 2. In addition, the display device 4 can receive image data and the like of the workpiece W output from the control unit 2. The display device 4 and the control unit 2 are connected via the communication cable 7. Thus, the display device 4 can be installed at a place away from the installation place of the control unit 2.

Note that, the PC 3 and the display device 4 may be integrally provided. For example, the display device 4 may be constituted by a display device included in the PC 3. In this case, a body portion of the PC 3 and the display device 4 may be integrated with each other or may be separated from each other. In addition, in this example, the communication board 22 and the PLC 5 are connected via the communication cable 7.

### (Configuration of Control Unit)

As illustrated in FIG. 2, the control unit 2 includes the head communication section 20, the controller 21, the communication board 22, a power supply 23, a connector board 24, an I/O board 25, and a storage device (storage section) 26. The head communication section 20 is a portion that is connected to the controller 21 and executes communication between the controller 21 and the image capturing unit 1. A control signal of the image capturing unit 1 output from the controller 21 is transmitted to the image capturing unit 1 via the head communication section 20. The control signal of the image capturing unit 1 includes a signal for controlling a light emission timing and a light emission amount of the LED 10a and a signal for controlling the AF motor 11a and the capturing board 11b. In addition, the image data acquired by the image capturing unit 1 is output from the image capturing unit 1 and is then transmitted to the controller 21 via the head communication section 20.

The controller 21 includes a DSP 21a and an FPGA 21b that execute various kinds of signal processing, an accelerator 21c for speeding up processing, and a memory 21d including a RAM, a ROM, and the like. A specific configuration of the controller 21 will be described later.

The communication board 22 is a member that is connected to the controller 21 and executes communication between the controller 21, the PC 3, the display device 4, and the PLC 5.

The connector board 24 includes a power supply interface 24a. A power cable (not illustrated) for supplying power from an outside is connected to the power supply interface 24a. The connector board 24 and the power supply 23 are connected, and power supplied from the outside to the power supply interface 24a is adjusted to a predetermined voltage by the power supply 23 and is then supplied to the controller 21. The power supplied to the controller 21 is supplied to the image capturing unit 1 via the head communication section 20.

The I/O board 25 is connected to the controller 21. The inspection result output from the controller 21 is input to the PLC 5 via the I/O board 25.

### (Functional Block)

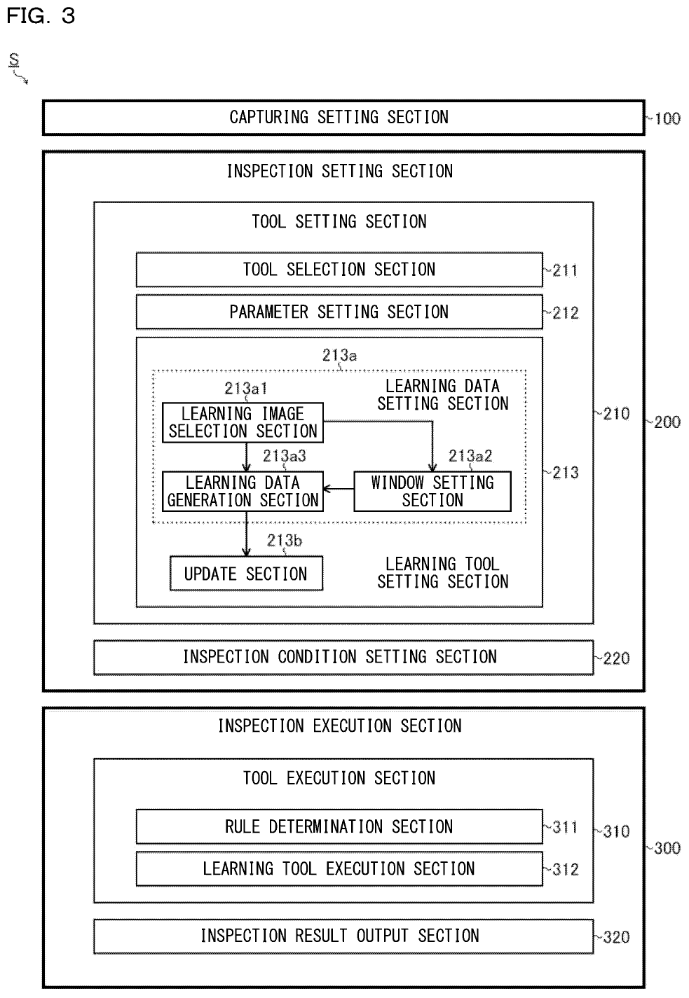

FIG. 3 is a functional block diagram of the image inspection device S. As illustrated in this drawing, the image inspection device S includes, as functional blocks thereof, a capturing setting section 100, an inspection setting section 200, and an inspection execution section 300.

The capturing setting section 100 performs various settings (capturing field of view, brightness of image, focus, capturing interval (frame rate), and the like) regarding a capturing operation of the image capturing unit 1.

The inspection setting section 200 performs various settings regarding the inspection of the captured image by the inspection execution section 300. In accordance with this drawing, the inspection setting section 200 includes a tool setting section 210 and an inspection condition setting section 220.

The tool setting section 210 sets various tools. In accordance with this drawing, the tool setting section 210 includes a tool selection section 211, a parameter setting section 212, and a learning tool setting section 213.

The tool selection section 211 selects a tool to be set and a tool to be used.

The parameter setting section 212 sets a rule-based tool. In the rule-based tool, the inspection is performed based on various feature amounts (contour, color, position, and the like) of the workpiece W appearing in the image.

The learning tool setting section 213 sets a tool of a learning system using a machine learning model. In the tool of the learning system, a trained model such as a discriminator is generated according to the teaching of the user, and the inspection is performed based on an output from the trained model. In accordance with this drawing, the learning tool setting section 213 includes a learning data setting section 213a and an update section 213b. The machine learning model may include a neural network.

The learning data setting section 213a sets learning data to be input to the machine learning model. The learning data includes a learning image and a teaching content. The learning image is an image on which the workpiece W appears. The teaching content is setting information of a window indicating a region in which the workpiece W appears. In accordance with this drawing, the learning data setting section 213a includes a learning image selection section 213a1, a window setting section 213a2, and a learning data generation section 213a3.

The learning image selection section 213a1 selects a learning image. The learning image may be an image captured by the image capturing unit 1 or an image transmitted from the PC 3 and stored in the storage device 26.

The window setting section 213a2 displays the learning image selected by the learning image selection section 213a1 on the GUI and receives window setting for the learning image.

The learning data generation section 213a3 generates learning data based on the learning image selected by the learning image selection section 213a1 and the window setting received by the window setting section 213a2.

The update section 213b updates parameters of the machine learning model such that the output of the machine learning model approaches an expected value according to the teaching content. The updating of the parameter may be understood as learning of the machine learning model. However, the learning of the machine learning model does not necessarily need to be performed by the user in all processes. For example, learning with a relatively large calculation amount may be completed on a vendor side before shipment of the image inspection device S, and only learning with a relatively small calculation amount may be performed on the user side before operation of the image inspection device S. In the present specification, learning performed by the vendor side before shipment is referred to as pre-shipment learning, and learning performed by the user before operation of the image inspection device S is referred to as customer learning.

For example, the machine learning model of the image inspection device S includes a feature extraction section in which customer learning is not performed and a determination section in which customer learning is performed. The feature extraction section extracts a feature amount from the image input to the machine learning model. The determination section outputs an inspection result from the feature amount.

That is, the machine learning model of the image inspection device S may include a parameter fixed portion. The parameter fixed portion is a layer in which a parameter obtained by pre-shipment learning on the vendor side is fixed, in other words, a layer in which customer learning on the user side is unnecessary.

With this configuration, it is not necessary for the user to prepare, for example, the GPU or the like as a facility with high processing capability required for deep learning, or for the vendor to provide an advanced learning environment by the GPU or the like as a cloud service (SaaS or the like). Therefore, an introduction barrier of the image inspection device S is lowered.

As described above, the learning should be understood in a broad sense as not only referring to deep learning with a large calculation amount but also including learning with a small calculation amount, that is, the customer learning in the present specification. Note that, since the customer learning is learning with a small calculation amount, the machine learning model may be trained by a method that does not include a machine learning method.

The inspection condition setting section 220 determines an output condition of the image inspection device S, in other words, a condition of the sensor output, for example, by combining a plurality of tools.

The inspection execution section 300 executes inspection processing of the workpiece W appearing in the captured image and outputs the inspection result. In accordance with this drawing, the inspection execution section 300 includes a tool execution section 310 and an inspection result output section 320.

The tool execution section 310 executes a tool selected as a use target by the tool selection section 211. In accordance with this drawing, the tool execution section 310 includes a rule determination section 311 and a learning tool execution section 312.

In a case where the tool selection section 211 selects a rule-based tool as the use target, the rule determination section 311 executes the rule-based tool.

In a case where the tool selection section 211 selects the tool of the learning system as the use target, the learning tool execution section 312 executes the tool of the learning system.

The inspection result output section 320 outputs the inspection result according to the output condition set by the inspection condition setting section 220. The inspection may include image classification, abnormality detection, region segmentation, and the like.

Each of the capturing setting section 100, the inspection setting section 200, and the inspection execution section 300 may be constituted only by hardware, or may be constituted by a combination of hardware and software. In addition, each of the capturing setting section 100, the inspection setting section 200, and the inspection execution section 300 may be independent, or may be configured such that a plurality of functions is realized by one piece of hardware or software. Note that, the software can be executed by the control unit 2 (in particular, the controller 21) in which a program file and a setting file are installed.

The image inspection device S of the present configuration example can be switched between a setting mode and a driving mode. In the setting mode, for example, various parameter settings such as capturing settings, registration of a master image, and generation (learning) of a classifier that classifies an image into a class based on a feature amount of the image are performed. Note that, the classification as used herein is to classify an image into any class, and includes classifying an image into a non-defective product image and a defective product image, and classifying an image into an image on which an object appears and an image on which an object does not appear.

In the driving mode, the workpiece W is inspected based on the captured image captured by the image capturing unit 1 at an actual site. The switching between the setting mode and the driving mode can be performed on a GUI to be described later. In addition, it is also possible to configure to automatically shift to the driving mode simultaneously with finish of the setting mode. In the driving mode, it is also possible to correct (update) a classification boundary in the classifier, that is, to perform so-called additional learning.

### (Learning Search)

The image inspection device S includes a learning search tool that implements a “learning search” function as one of tools of a learning system using the machine learning model. The learning search tool is a tool for learning a visual characteristic of a search object that is an object to be searched for and searching for the search object from the captured image, in other words, detecting the search object from the captured image. In the following description, “learning search” may be used as a term indicating the learning search tool.

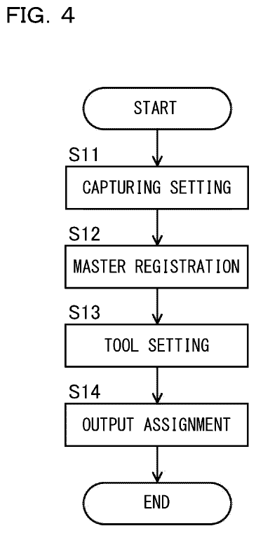

FIG. 4 is a diagram illustrating a flow (setting flow) in the setting mode. Note that, an execution subject of the setting flow illustrated in FIG. 4 can be basically understood as the inspection setting section 200.

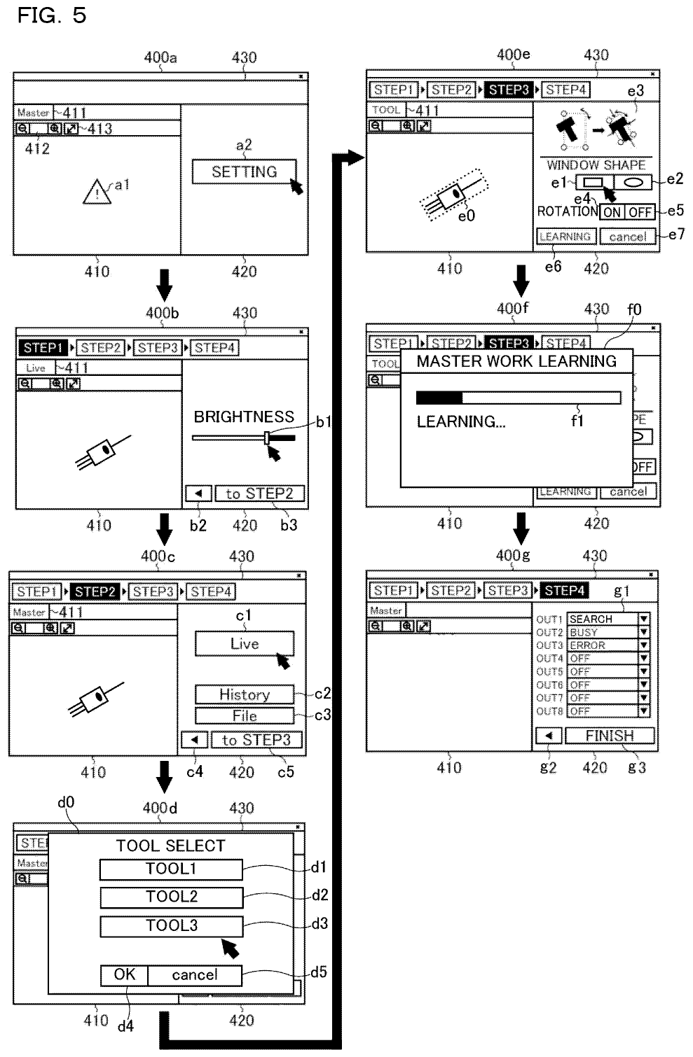

FIG. 5 is a diagram illustrating GUI transition corresponding to the setting flow illustrated in FIG. 4. When an image inspection program is executed by the PC 3, a GUI 400 is displayed on the display device 4. The GUI 400 (=various screens 400a to 400g) corresponding to the setting flow illustrated in FIG. 4 includes, as a basic layout thereof, an image display region 410, an operation region 420, and a progress display region 430.

In the image display region 410, the captured image or the like captured by the image capturing unit 1 is displayed. In addition, the image display region 410 may be accompanied by a state display banner 411, an enlargement and reduction button 412, a maximum display button 413, and the like. In the state display banner 411, an operation state (status) of the image inspection program is briefly displayed. The enlargement and reduction button 412 and the maximum display button 413 are operated when the image displayed in the image display region 410 is enlarged or reduced and maximized, respectively.

When the image inspection device S is activated for the first time, an initial activation screen 400a is displayed. Note that, at the time of the first activation of the image inspection device S, various settings of the image inspection program are not finished. Thus, an alert mark a1 (or alert message) indicating that a master image is unregistered may be displayed in the image display region 410. In addition, a banner (for example, “Master”) indicating that the master image is unregistered (or is being registered) may be displayed on the state display banner 411.

In addition, for example, a setting start button a2 is displayed in the operation region 420 of the initial activation screen 400a. When the setting start button a2 is clicked (or tapped, and the same applies later), various settings of the image inspection program are started. This start corresponds to the start of the setting flow illustrated in FIG. 4. In addition, the switching from the driving mode to the setting mode also corresponds to the start of the setting flow illustrated in FIG. 4.

In the setting flow illustrated in FIG. 4, a first process (capturing setting) in step S11, a second process (master registration) in step S12, a third process (tool setting) in step S13, and a fourth process (output assignment) in step S14 are sequentially advanced. In the progress display region 430, each process may be displayed on a flowchart, and the process currently being executed may be highlighted. With such a configuration, the user can grasp a progress status of the setting work at a glance.

In the first process (capturing setting) of step S11, a capturing setting screen 400b is displayed. In the operation region 420 of the capturing setting screen 400b, for example, a slide bar b1, a back button b2, and a forward button b3 may be displayed.

When the slide bar b1 is moved by dragging, the brightness of the image corresponding to the movement of the slide bar b1 is set. Although not explicitly illustrated in FIG. 5, in the first process (capturing setting), the capturing field of view, focus, capturing interval (frame rate), and the like may be set.

When the back button b2 is clicked, the screen returns to the initial activation screen 400a described above. On the other hand, when the forward button b3 is clicked, the process proceeds to the second process (master registration).

Note that, as illustrated in FIG. 5, in the first process (capturing setting), a live image (=moving image being captured) may be displayed in the image display region 410. In this case, the state display banner 411 may display a banner (for example, “Live”) indicating that a live image is being displayed.

In the second process (master registration) of step S12, a master image selection screen 400c is displayed. In the operation region 420 of the master image selection screen 400c, for example, a live button c1, a history button c2, a file button c3, a back button c4, and a forward button c5 may be displayed.

When the live button c1 is clicked, the live image displayed in the image display region 410 at this point in time is registered as the master image. Note that, the master image can be registered from a driving history image (inspected image) by clicking the history button c2. In addition, the master image can be registered from a file image stored in the storage device 26 by clicking the file button c3. As described above, examples of a setting method for registering the master image include a method for registering from the live image, a method for registering from the driving history image, and a method for registering from the file image.

When the back button c4 is clicked, the process returns to the first process (capturing setting) described above. On the other hand, when the forward button c5 is clicked, the process proceeds to the third process (tool setting).

In the third process (tool setting) of step S13, first, a tool selection screen 400d is displayed. For example, as illustrated in FIG. 5, a tool selection dialog d0 may be displayed on the tool selection screen 400d.

In the tool selection dialog d0, for example, a first tool (color area) button d1, a second tool (learning search) button d2, a third tool (learning optical character recognition [OCR]) button d3, an OK button d4, and a cancel button d5 are displayed. The color area is a rule-based tool for measuring an area of a predetermined color. Each of the learning search and the learning OCR is the tool of the learning system. As described above, the learning search is a tool for learning the visual characteristic of the search object and searching for the search object from the captured image. The learning OCR is a tool for learning characteristics of characters and identifying characters from the captured image.

When the first tool (color area) button d1 is clicked, the first tool (color area) is selected. When the second tool (learning search) button d2 is clicked, the second tool (learning search) is selected. When the third tool (learning OCR) button d3 is clicked, the third tool (learning OCR) is selected.

In the tool selection dialog d0, guidance for displaying an outline and a schematic diagram of the tool selected from the first tool (color area), the second tool (learning search), and the third tool (learning OCR) may be displayed.

When the OK button d4 is clicked, a selection state of the tool is confirmed. On the other hand, when the cancel button d5 is clicked, the selection state of the tool is canceled and the tool selection dialog d0 is closed. The following description is based on the assumption that the second tool (learning search) is selected on the tool selection screen 400d (tool selection dialog d0).

When the selection state of the tool is confirmed, an object selection screen 400e is displayed. In the operation region 420 of the object selection screen 400e, for example, a rectangular button e1, an elliptical button e2, a guidance e3, a rotation automatic learning ON button e4, a rotation automatic learning OFF button e5, a learning start button e6, and a cancel button e7 may be displayed. In addition, a banner (for example, “TOOL”) indicating that the tool is being set may be displayed on the state display banner 411.

On the object selection screen 400e, the search object appearing in the registered master image is designated by setting of a window e0. For example, when the rectangular button e1 is clicked, a rectangular window e0 is displayed in the image display region 410. When the elliptical button e2 is clicked, an elliptical window (not illustrated) is displayed in the image display region 410. A shape of the window e0 may be a shape other than a rectangle or an ellipse (for example, a chamfered rectangle) as long as lengths in a width direction and a height direction orthogonal to each other are different from each other. Note that, in the guidance e3, a method for designating a target region or the like may be displayed.

The user can designate the search object by adjusting a position, a size, and an angle of the window e0 so as to surround the search object appearing in the master image according to the guidance e3. The position of the window e0 is a position of the window e0 with respect to the master image. The angle of the window e0 is an angle of the window e0 with respect to the master image.

The image inspection device S has a function (rotation automatic learning function) of automatically learning a state where the search object is rotated. When the rotation automatic learning ON button e4 is clicked, the rotation automatic learning function is enabled. When the rotation automatic learning OFF button e5 is clicked, the rotation automatic learning function is disabled.

When the learning start button e6 is clicked after the search object is designated, the learning of the machine learning model used in the learning search is started. On the other hand, when the cancel button e7 is clicked, the designation of the search object is canceled.

When the learning of the machine learning model is started, a learning progress screen 400f is displayed. Note that, a learning progress dialog f0 may be displayed on the learning progress screen 400f as illustrated in FIG. 5. In the learning progress dialog f0, for example, a learning progress bar f1 indicating a degree of progress (0% to 100%) is displayed. When the learning of the machine learning model is finished, the process proceeds to the fourth process (output assignment).

In the fourth process (output assignment) of step S14, an output assignment screen 400g is displayed. In the operation region 420 of the output assignment screen 400g, for example, a pull-down menu g1 of each of output ports OUT1 to OUT8, a back button g2, and a finish button g3 may be displayed.

In the pull-down menu g1, a plurality of candidates is displayed as output contents of each of the output ports OUT1 to OUT8. In this drawing, a search result (SEARCH) of the workpiece W is selected as the output content of the output port OUT1. In addition, a busy detection result (BUSY) is selected as the output content of the output port OUT2. In addition, an error detection result (ERROR) is selected as the output content of the output port OUT3. In addition, all of the output ports OUT4 to OUT8 are unused (OFF). With this configuration, not only the search result of the workpiece W but also various kinds of information such as a busy detection result and an error detection result can be output in multiple bits.

When the back button g2 is clicked, the process returns to the third process (tool setting) described above. On the other hand, when the finish button g3 is clicked, the setting work is finished.

In a period in which the learning progress screen 400f described above is displayed, the image inspection device S (in particular, the inspection setting section 200) executes the following processing as the learning of the machine learning model.

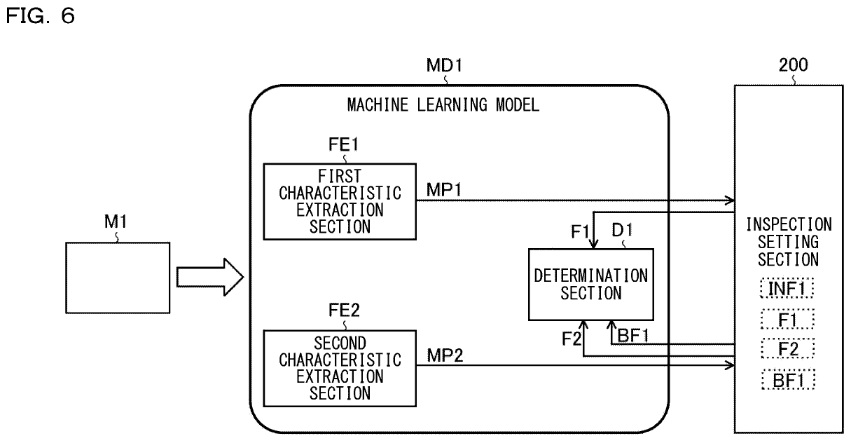

As illustrated in FIG. 6, the image inspection device S (particularly, the inspection setting section 200) inputs a learning image (master image) M1 to a machine learning model MD1. The machine learning model MD1 includes a first feature extraction section FE1, a second feature extraction section FE2, and a determination section D1. Note that, the first feature extraction section FE1 and the second feature extraction section FE2 may be different feature extraction sections from each other, or may be the same feature extraction section.

The inspection setting section 200 executes the first feature extraction section FE1 to extract a first feature map MP1 from the learning image (master image) M1. In addition, the inspection setting section 200 extracts a first feature amount F1 corresponding to a position specified by the window (predetermined position inside the window) from the first feature map MP1 based on window setting information INF1. The predetermined position inside the window is, for example, a center position of the window, but may be a position uniquely determined inside the window even though the position is other than the center position. Since the window is set so as to surround the search object appearing in the learning image (master image) M1, when an angle (orientation) of the search object changes, the first feature amount F1 corresponding to the position specified by the window (predetermined position inside the window) also changes. That is, the first feature amount F1 is a feature amount reflecting an angle of the window with respect to the learning image (master image) M1. A parameter of the determination section D1 is updated according to the first feature amount F1.

The inspection setting section 200 executes the second feature extraction section FE2 to extract a second feature map MP2 from the learning image (master image) M1. In addition, the inspection setting section 200 extracts the second feature amount F2 corresponding to the position specified by the window (predetermined position inside the window) from the second feature map MP2 based on the window setting information INF1. Further, the inspection setting section 200 extracts a background feature amount BF1 corresponding to a background position other than the window from the second feature map MP2 based on the window setting information INF1. The parameter of the determination section D1 is updated according to the background feature amount BF1. Since the parameter of the determination section D1 is updated according to the background feature amount BF1 without performing an operation of designating the background in this manner, the determination accuracy in the determination section D1 can be improved without increasing a time and effort.

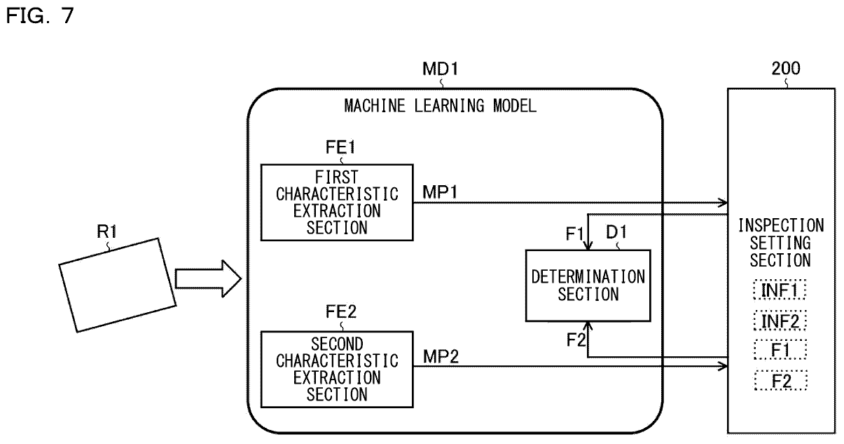

In addition, in a case where the rotation automatic learning function is enabled, the inspection setting section 200 generates a rotation image R1 obtained by rotating the learning image (master image) M1 with a predetermined position of the learning image (master image) M1 as a rotation center. Note that, a window in the rotation image R1 is obtained by rotating the window in the learning image (master image) M1 with a predetermined position of the learning image (master image) M1 as a rotation center. In a case where the learning image is rotated every α°, 360/α (however, rounded down to the nearest whole number in the case of not an integer) rotation images R1 are generated. Then, the image inspection device S (in particular, the inspection setting section 200) inputs the rotation image R1 to the machine learning model MD1 as illustrated in FIG. 7.

Then, the inspection setting section 200 executes the first feature extraction section FE1 to extract the first feature map MP1 from the rotation image R1. In addition, based on the window setting information INF1 and rotation angle information INF2, the inspection setting section 200 extracts the first feature amount F1 corresponding to the position specified by the window in the rotation image R1 (predetermined position inside the window) from the first feature map MP1, and stores the first feature amount F1 and the rotation angle information INF2 in association with each other. The parameter of the determination section D1 when the rotation automatic learning function is enabled is updated according to the first feature amount F1 associated with the rotation angle information INF2.

After the setting flow illustrated in FIG. 4 is ended and the setting mode is switched to the driving mode, the learning search is executed on the captured image captured by the image capturing unit 1. An execution subject of the learning search can be basically understood as the inspection execution section 300.

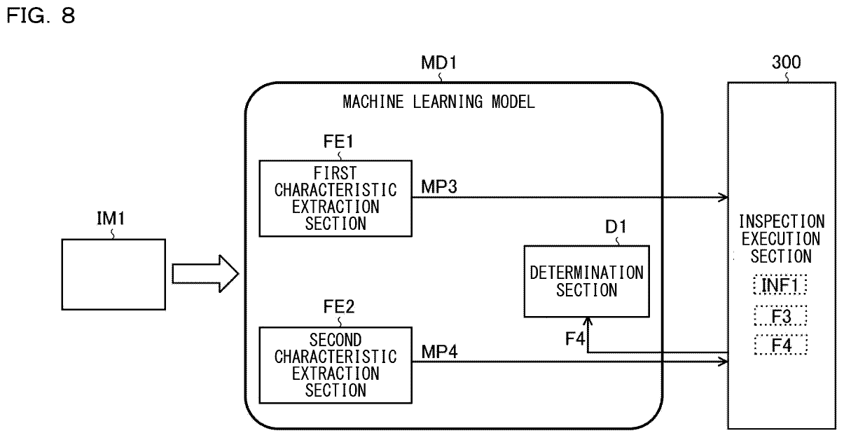

As illustrated in FIG. 8, the image inspection device S (in particular, the inspection execution section 300) inputs the captured image IM1 to the machine learning model MD1.

The inspection execution section 300 executes the first feature extraction section FE1 to extract a third feature map MP3 from the captured image IM1. In addition, the inspection execution section 300 extracts a third feature amount F3 similar to the first feature amount F1 from among the feature amounts included in the third feature map MP3. As a method for extracting the third feature amount F3 similar to the first feature amount F1, there is a method for obtaining a vector similarity of each feature amount included in the third feature map MP3 with the first feature amount F1 and extracting, as the third feature amount F3, a feature amount having a vector similarity equal to or greater than a threshold, but the method is not limited thereto. The inspection execution section 300 specifies a position corresponding to the third feature amount F3 in the captured image IM1 and determines a candidate region based on the specified position and the window setting information INF1. A position specified by the candidate region (a predetermined position inside the candidate region) becomes a position corresponding to the third feature amount F3, a size of the candidate region coincides with the size of the window, and an angle of the candidate region with respect to the captured image IM1 coincides with the angle of the window of the learning image (master image) M1.

The inspection execution section 300 executes the second feature extraction section FE2 to extract a fourth feature map MP4 from the captured image IM1. In addition, the inspection execution section 300 extracts the fourth feature amount F4 corresponding to the specified position (position corresponding to the third feature amount F3 in the captured image IM1) described above from the fourth feature map MP4.

The inspection execution section 300 executes the determination section D1 to make a classification based on whether or not the fourth feature amount F4 belongs to the same class as the second feature amount F2, that is, a class indicating the search object, and outputs an inspection result in which the candidate region described above is set as a detection region of the object in a case where the fourth feature amount F4 is classified as belonging to the same class as the second feature amount F2. The inspection result when the inspection execution section 300 executes the learning search includes the detection result including the detection of the object from the captured image IM1, the position of the detection region of the object in the captured image IM1, and the like, and the inspection result in a narrow sense indicating that the detected object is the search object. That is, when a non-defective object is set as the search object, an inspection result equivalent to a result of performing detection of whether or not the object is included in the captured image IM1 and determination of whether or not the object is the non-defective product in a case where the object is included in the captured image IM1 is output. In a case where there is a plurality of fourth feature amounts F4 classified as belonging to the same class as the second feature amount F2, the inspection execution section 300 may output the detection result in which each of the plurality of candidate regions are set as the detection region of the object. In addition, an inspection range of another tool (for example, learning OCR) may be determined based on the detection region as the detection result. For example, in a case where the object is a printed portion of the product, the candidate region may be set as the inspection range of the learning OCR.

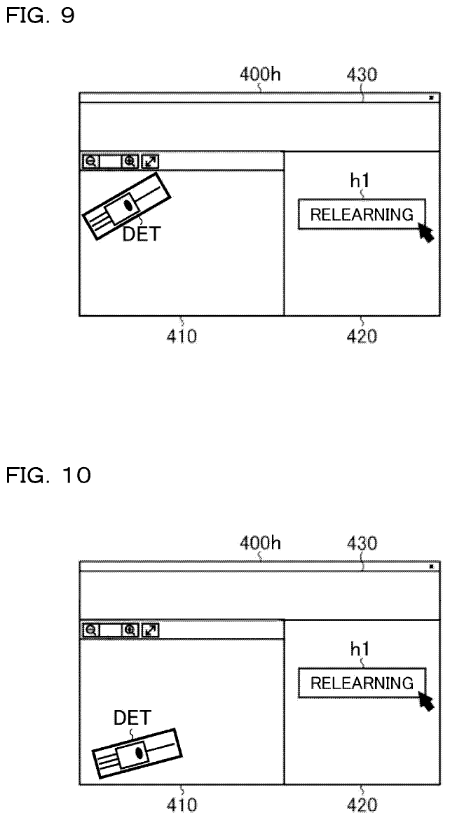

A detection region DET1 of the search object is displayed as a frame like a detection result screen 400h illustrated in FIG. 9, for example. Since the object is searched for by extracting the third feature amount F3 similar to the first feature amount F1, even though the position of the object detected as the search object appearing in the captured image IM1 is away from the position of the window of the learning image (master image) M1, the image inspection device S can detect the object detected as the search object. Further, in a case where the rotation automatic learning function is enabled, even though the angle of the object appearing in the captured image IM1 is greatly different from the angle of the window of the learning image (master image) M1, the image inspection device S can detect the search object (see the detection result screen 400h illustrated in FIG. 10).

### (Additional Learning)

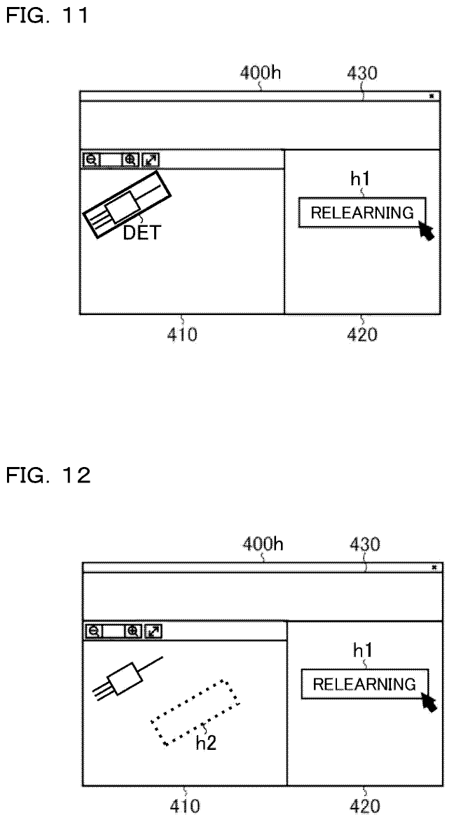

For example, as in the detection result screen 400h illustrated in FIG. 11, the object that is not the search object (an article having a black elliptical mark missing unlike the search object) is erroneously detected. The additional learning is performed, and thus, the erroneous detection can be prevented in the learning search performed after the additional learning.

When an additional learning button h1 displayed in the operation region 420 of the detection result screen 400h is clicked, the inspection setting section 200 performs the additional learning. Specifically, the inspection setting section 200 sets, as an additional learning window, the detection region DET1 of the object displayed in the image display region 410 at a point in time when the additional learning button h1 is clicked, sets, as an additional learning feature map of the additional learning image, the third feature map MP3 of the captured image IM1 displayed in the image display region 410 at a point in time when the additional learning button h1 is clicked, and extracts the additional learning feature amount corresponding to the position specified by the additional learning window from the additional learning feature map. The parameter of the determination section D1 is updated according to the additional learning feature amount. The parameter of the determination section D1 is updated such that the background feature amount FB1 and the additional learning feature amount belong to the same class (class indicating that the background feature amount FB1 is not the object), and the second feature amount F2 belongs to a class different from the additional learning feature amount (a class indicating that the background feature amount FB1 is the object).

The additional learning is performed by using the captured image IM1 displayed on the detection result screen 400h in this manner, and thus, it is possible to reduce the number of operations related to the performing of the additional learning. Note that, instead of using the captured image IM1 displayed on the detection result screen 400h, an object that is not the search object appearing in the additional learning image may be designated in the additional learning window in the setting mode.

### (Undetected Display)

In a case where the search object is not detected as a result of performing the learning search, the inspection execution section 300 may output, as the detection result, an image indicating that there is no detection region of the search object superimposed on the captured image. As a result, even in a case where the search object is not detected, the user can clearly grasp that the learning search is performed. As the image indicating that there is no detection region of the search object, for example, a display image in which an aspect (color, thickness, or the like) of the window set in the learning image (master image) M1 is changed can be considered.

In a case where the object to be detected as the search object is not displayed in the image display region 410 of the detection result screen 400h and the object that is not the search object is not erroneously detected, for example, as in the detection result screen 400h illustrated in FIG. 12, an image h2 indicating that there is no detection region of the search object may be displayed.

### <Others>

Note that, in addition to the embodiment, various modifications can be made to various technical characteristics disclosed in the present specification without departing from the spirit of the technical creation. That is, it should be considered that the embodiment is illustrative in all respects and not restrictive. In addition, the technical scope of the invention is defined by the claims, and should be understood to include all modifications falling within the meaning and scope equivalent to the claims.

For example, in the embodiment, although the camera module 11 and the controller 21 are separate bodies, the camera module 11 and the controller 21 may be integrated (a relative positional relationship between the camera module 11 and the controller 21 is fixed), that is, the camera module 11, the inspection execution section 300, and the inspection setting section 200 may be integrated (a relative positional relationship between the camera module 11, the inspection execution section 300, and the inspection setting section 200 is fixed).

In a case where the camera module 11 and the controller 21 are integrated, an extending direction of a connector provided in a housing that houses the camera module 11 and the controller 21 can be changed without being restricted by the relative positional relationship between the camera module 11 and the controller 21. That is, in a case where the camera module 11 and the controller 21 are integrated, a degree of freedom in disposition of the image inspection device S increases.

In a case where the “position correction tool” disclosed in JP2022-164146A is used, when the degree of freedom in disposition of the image inspection device S is large, since there is a high possibility that the setting of the “position correction tool” becomes difficult or impossible, it is necessary to perform a confirmation work as to whether or not the “position correction tool” can be used, or there are many opportunities to change the disposition of the image inspection device S, and it becomes troublesome to reset the “position correction tool”.

On the other hand, in a case where the “learning search” is used, even though the degree of freedom in disposition of the image inspection device S is large, an additional work required in a case where the “position correction tool” is used becomes unnecessary. Accordingly, when the “learning search” is used, the substantial degree of freedom in disposition of the image inspection device S in consideration of the additional work is increased as compared with the case where the “position correction tool” is used.

In a case where the camera module 11 and the controller 21 are integrated, the illumination module 10 may also be integrated with the camera module 11 and the controller 21.

In a case where the illumination module 10 is integrated with the camera module 11 and the controller 21, the disposition of the image inspection device S becomes easy, but a relative positional relationship between the illumination module 10 and the camera module 11 cannot be adjusted.

In a case where the “position correction tool” disclosed in JP2022-164146A is used, when a visual characteristic suitable for setting a reference position and a reference angle of the “position correction tool” is influenced by halation or the like, the influence cannot be reduced by adjusting the relative positional relationship between the illumination module 10 and the camera module 11.

On the other hand, in a case where the “learning search” is used, the “learning search” can be executed without any problem even though the visual characteristic suitable for setting the reference position and the reference angle of the “position correction tool” is influenced by halation or the like.

The camera module 11 may have a zoom function.

In a case where the “position correction tool” disclosed in JP2022-164146A is used, the visual characteristic suitable for setting the reference position and the reference angle of the “position correction tool” may deviate from the capturing field of view due to zoom-in of a zoom function, and setting of the “position correction tool” may become impossible.

On the other hand, in a case where the “learning search” is used, the “learning search” can be executed without any problem even though the visual characteristic suitable for setting the reference position and the reference angle of the “position correction tool” is out of the capturing field of view by zooming in of the zoom function.

What is claimed is:

1. An image inspection device comprising:
an image capturing section that captures a capturing field of view to generate a captured image;
an inspection execution section that detects an object from the captured image by a machine learning model to output an inspection result; and
an inspection setting section that performs setting of the inspection execution section,
wherein the machine learning model includes a first feature extraction section and a second feature extraction section that extract feature amounts from an input image, and a determination section that outputs the inspection result from the feature amount,
the inspection setting section
receives window setting of a window for a learning image,
executes the first feature extraction section to extract a first feature map from the learning image, and extracts a first feature amount that is included in the first feature map,
reflects an angle of the window with respect to the learning image, and corresponds to a position specified by the window, and
executes the second feature extraction section to extract a second feature map from the learning image, and extracts a second feature amount that is included in the second feature map and corresponds to a position specified by the window, and
the inspection execution section
executes the first feature extraction section to extract a third feature map from the captured image, specifies a position corresponding to a third feature amount included in the third feature map and similar to the first feature amount, and determines a candidate region based on the specified position and the window setting,
executes the second feature extraction section to extract a fourth feature map from the captured image, and makes a classification based on whether or not a fourth feature amount included in the fourth feature map and corresponding to the specified position belongs to the same class as the second feature amount, and
outputs the inspection result in which the candidate region is set as a detection region of the object in a case where the fourth feature amount is classified as belonging to the same class as the second feature amount.

2. The image inspection device according to claim 1,
wherein the inspection setting section executes the first feature extraction section to extract the first feature map from each of the learning image and a rotation image obtained by rotating the learning image, and extracts the first feature amount,
the first feature amount is included in the first feature map, reflects the angle of the window with respect to the learning image, and corresponds to the position specified by the window, or is included in the first feature map, reflects an angle of the window with respect to the rotation image, and corresponds to the position specified by the window, and
the inspection execution section determines the candidate region based on the specified position, the window setting, and information regarding a rotation angle of the rotation image in a case where the third feature amount is similar to the first feature amount extracted from the rotation image.

3. The image inspection device according to claim 2,
wherein the inspection setting section
receives rotation setting,
executes the first feature extraction section to extract the first feature map from each of the learning image and the rotation image when the rotation setting is ON, and
executes the first feature extraction section to extract the first feature map from the learning image when the rotation setting is OFF.

4. The image inspection device according to claim 1,
wherein the inspection setting section executes the second feature extraction section to extract a second feature map from the learning image, and extracts a background feature amount included in the second feature map and corresponding to a background position other than the window, and
the inspection execution section makes a classification based on whether or not the fourth feature amount belongs to the same class as the second feature amount or the same class as the background feature amount.

5. The image inspection device according to claim 1,
wherein the learning image is a first learning image,
the window is a first window, and
the inspection setting section
receives second window setting for a second learning image different from the first learning image,
executes the second feature extraction section to extract a fifth feature map from the second learning image, and extracts a fifth feature amount included in the fifth feature map and corresponding to a position specified by the second window, and
the inspection execution section makes a classification based on whether the fourth feature amount belongs to the same class as the second feature amount or the same class as the fifth feature amount.

6. The image inspection device according to claim 5, wherein the inspection setting section is able to set the captured image as the second learning image and is able to set the detection region of the object as the second window in a state where the inspection result is output.

7. The image inspection device according to claim 1, wherein the inspection execution section outputs, as the inspection result, an image obtained by superimposing an image indicating that there is no detection region of the object on the captured image in a case where there is no detection region of the object.

8. The image inspection device according to claim 1, wherein the inspection execution section outputs the inspection result in which each of a plurality of the candidate regions is set as the detection region of the object in a case where there is a plurality of the fourth feature amounts classified as belonging to the same class as the second feature amount.

9. The image inspection device according to claim 1,
wherein the inspection result includes positional information indicating a position of the detection region in the captured image, and
the inspection execution section executes
a first inspection for detecting the object, and
a second inspection different from the first inspection in which an inspection range is determined based on the positional information included in the inspection result by the first inspection.

10. The image inspection device according to claim 1, wherein the image capturing section, the inspection execution section, and the inspection setting section are integrated.
